(19) United States
(12) Patent Application Publication
(10) Pub. No.: US 2008/0000755 A1
(43) Pub. Date: Jan. 3, 2008

(54) Loader and method for loading carton blanks

(76) Inventor: Sinan Unalp, Novi, MI (US)

Correspondence Address: CALFEE HALTER & GRISWOLD, LLP, 800 SUPERIOR AVENUE, SUITE 1400, CLEVELAND, OH, 44114, US

(21) Appl. No.: 11/479,656

(22) Filed: Jun. 30, 2006

(51) Int. Cl. B65G 47/26

(52) U.S. Cl. 198/457.01

(57) ABSTRACT

A loader for loading flat carton sleeves into a magazine of a carton filling machine includes a conveyor having a loading section at a height that is easily accessible to an operator standing on the floor. The loader has queuing positions in which stacks of carton sleeves are accumulated before being delivered to the magazine from a delivery section of the conveyor.

### BACKGROUND

A typical filling machine, such as one used in a dairy, accepts packaging articles, such as flat carton sleeves. The flat carton sleeves are loaded into several magazines, from which they are fed into the machine by being drawn one at a time from the bottom of a stack in a magazine. The machine erects the sleeves to form cartons, then fills and seals the cartons.

The carton sleeves may be loaded by hand into one of several belt conveyors that feed the magazines. The belt conveyors are at different heights above the floor and extend parallel to the floor. The uppermost belt conveyors are high enough off the floor that the operator must stand on a platform to load the belt conveyor. Even the lower belt conveyors are high enough off the floor that the operator must reach upward, above an ergonomic level, to load the belt conveyor. In addition, some carton sleeves are made of a slippery material, so it can be difficult to grasp a large number and lift them overhead without spilling; this can limit the number of sleeves that can be lifted at one time, and consequently increase the number of lifts required.

### BRIEF DESCRIPTION OF THE DRAWINGS

In the accompanying drawings:

FIG. 1 illustrates a loader that is a first embodiment of the invention, shown in association with a filling machine;

FIG. 2 is a perspective view of the loader of FIG. 1;

FIG. 3 is a partial perspective view of a first portion of the loader of FIG. 1;

FIGS. 4-11 are a series of schematic views illustrating operation of the loader of FIG. 1;

FIGS. 12 and 13 are schematic views illustrating another feature of the present embodiment of the invention; and

FIG. 14 is an illustration of two loaders shown in association with a portion of a filling machine and on respective opposite sides of the machine.

### DETAILED DESCRIPTION

The present invention relates to a loader and method for loading carton blanks, and to a magazine for blanks. The invention is applicable to apparatus and methods of differing constructions and modes of operation, and as such is not intended to be limited by this description of one or more tangible embodiments of the invention.

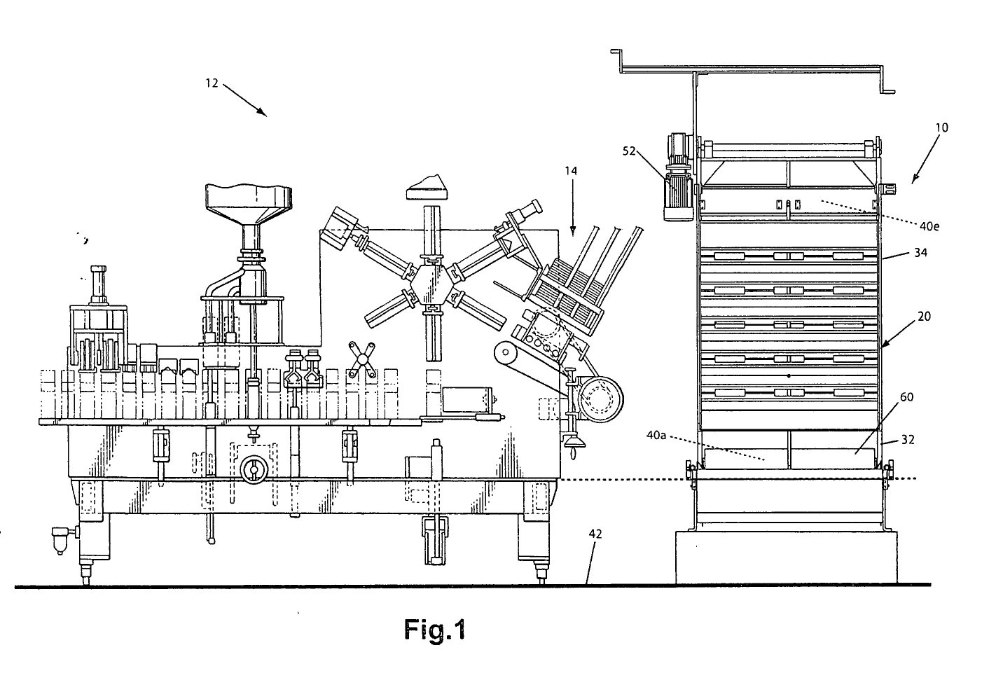

As representative of the invention, FIG. 1 illustrates schematically a forwarding device, or loader, 10 that is a first embodiment of the invention. The loader 10 is shown associated with a carton filling machine 12. The particular filling machine 12 that is illustrated is only representative of the various different types of machines with which the loader 10 can be used or associated.

The carton filling machine 12 includes a magazine 14 to be stocked with carton blanks. Downstream of the magazine 14 (to the left as viewed in FIG. 1) the filling machine 12 includes apparatus for erecting the flat carton sleeves and thereafter filling and sealing the carton sleeves. The structure and operation of such filling machines are known in the art, and are therefore not described in detail herein.

The filling machine 12 may be of the type with more than one lane, and with more than one magazine per lane. One known filling machine uses two magazines per lane. The loader 10 that is shown and described herein is particularly designed to accommodate (load) two magazines per lane.

The loader 10 includes an accumulating conveyor 20 that includes, as described below, a loading section, a queuing section, and a delivery section. The conveyor 20 is an endless conveyor that can be indexed either manually or automatically, as described below. The filling machine typically includes one conveyor 20 for each lane. The conveyor 20 includes carriers 60 in the form of trays each having two compartments. Each compartment can accept a stack of flat carton sleeves suitable for reloading a magazine. The loader 10 is operable to fill either one of the two magazines of a lane, from either of the two compartments. The invention is also applicable to the use of carriers with only one compartment, to filling machines with only one magazine, and to the provision of multiple loaders for a filling machine.

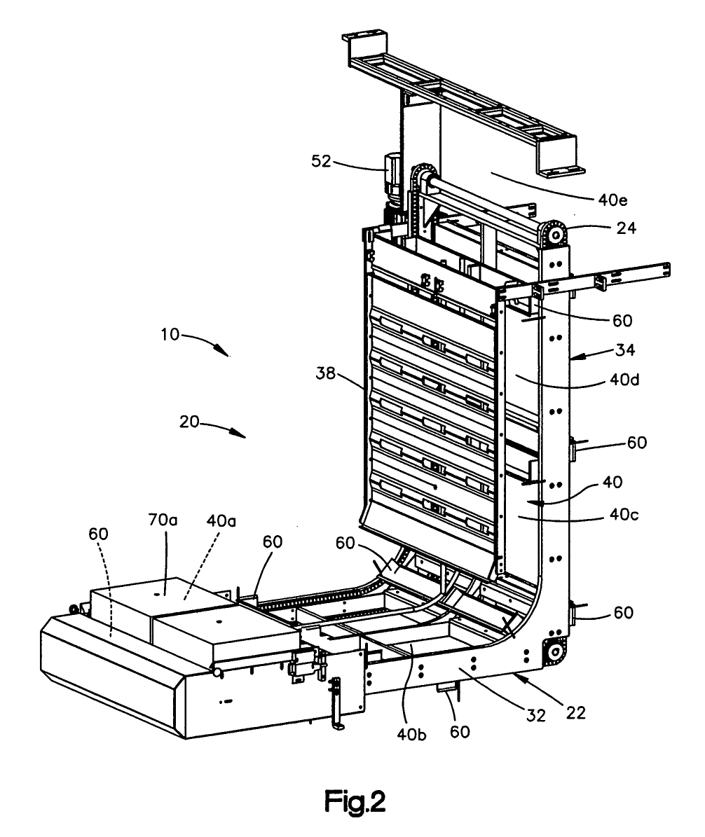

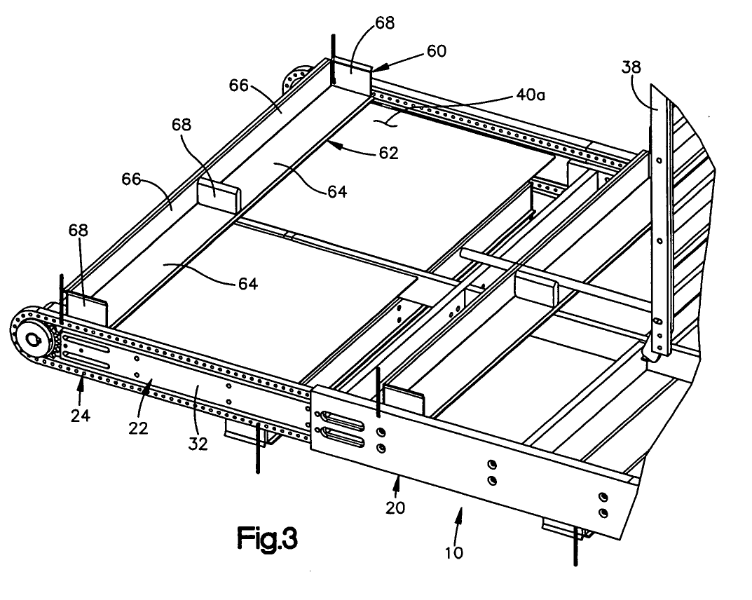

The conveyor 20 (FIGS. 2-4) includes a frame 22 that is fixed in position on or relative to the filling machine 12. The conveyor 20 also includes a carrier-supporting and -advancing arrangement 24 that is movable along the frame 22. The arrangement 24 bears a plurality of carriers 60 that move along the frame 22. As described below, the carriers 60 carry stacks of flat carton sleeves 70 that are manually loaded onto the conveyor 20 by the operator, to a location at which a gripper 84 can engage a stack of the carton sleeves. The gripper 84 is a robotic device, which may be part of the loader 20, and which is operable under electronic control to move a stack of carton sleeves from the conveyor 20 to the magazine 14.

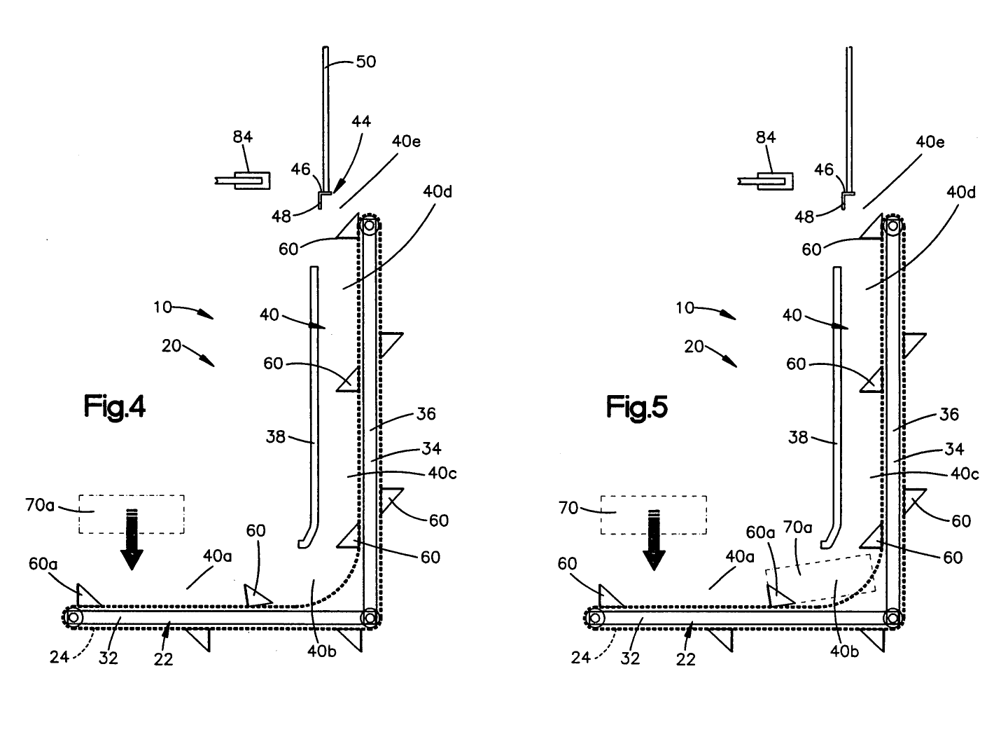

The conveyor frame 22 has a generally L-shaped configuration including a lower portion 32 and an upper portion 34. The upper portion 34 is spaced inward (to the right as viewed in FIG. 4) from the outer side of the lane and extends generally vertically in this particular embodiment. In other embodiments the frame 22 and thus the conveyor 20 can have a configuration other than L-shaped. Also, the upper portion 34 need not be vertical but may have any orientation adapted to lift carton sleeves from the lower portion 32 to a height at which a gripper can grip them for loading into a magazine, while preferably allowing accumulation or queuing of a number of flat carton sleeves at the same time, along the conveyor 20.

The upper portion 34 of the frame 22 includes a central frame portion 36 and a guide 38 that extend generally parallel to each other. The guide 38 is spaced outward (toward the operator and to the left as viewed in FIGS. 2-4) from the central frame portion 36.

The central frame portion 36 and the guide 38 define between them a conveying space 40. The conveying space 40 includes index positions or locations 40c and 40d of a series of index positions or locations (numbered 40c-40e in the drawings) into which stacks of flat carton sleeves are movable by the conveyor 20, as described below. The series of positions includes a top or delivery position 40e from which, as described below, a stack of carton sleeves can be moved to the magazine 14. The delivery position 40e is in the delivery section of the conveyor. The guide 38 does not extend in front of (outward of) the outer side of the delivery position 40e, and thus does not block access to the delivery position.

The positions 40c and 40d are intermediate or queuing positions, that is, positions between the loading position and the delivery position. The queuing positions are in the queuing section of the conveyor, between the loading section and the delivery section. In this embodiment the queuing positions are located below the delivery position 40e.

The queuing positions 40c and 40d are positions or locations in which completed groups of flat carton sleeves are stored, so that the conveyor 20, as a whole, can be said to accumulate carton sleeves. Also, it should be noted that the conveyor may be adapted to advance continuously rather than index.

The lower portion 32 of the frame 22 is oriented generally horizontally and extends outward from the bottom of the upper portion 34, to a location generally at the outer side of the filling machine 12 so that it is easily accessible to an operator standing at the outer side of the filling machine and at the outer side of the loader 10.

The lower portion 32 of the frame 22 includes the loading section of the conveyor, in which flat carton sleeves are manually loaded onto the conveyor by an operator. The outermost position 40a of the first or lower portion 32 of the frame 22 is a loading position of the conveyor 20. The loading position 40a is located at or near the outer edge of the loader 10 and the filling machine 12. This placement of the loading position 40a makes it easily accessible to an operator standing adjacent the machine 12, who does not have to reach laterally inward into the machine as he would if, for example, he were conventionally loading a belt conveyor directly.

The loading section of the conveyor is located at a relatively low level on the machine 12 and relative to the floor 42 on which the machine and the loader 10 rest, as compared to the height of the belt conveyors that would load the magazines, such as the magazine 14. This makes the loading section, including the loading position 40a, easily accessible to an operator standing adjacent the machine, who does not have to reach high up to load flat carton sleeves as he would if, for example, he were conventionally loading a belt conveyor directly. Preferably the loading section is at a height off the floor 42 which does not require the operator to stand on any kind of raised platform or stool. The loading height may be at hip height of the operator, for example. The loading section may be located in the range of, for example, from about 30 inches to about 40 inches off the floor. As one example, the loading section may be located at about 36 inches off the floor. Other heights are possible.

It is not necessary that the loading be done at the bottom of the conveyor. For example, a conveyor of the present invention may be arranged so that the stacks descend from hip level to virtually floor level and then up to a delivery level that is higher than the loading level, in which case the loading section would not be at the bottom of the conveyor.

The conveyor frame 22 supports a gate 44 (shown schematically in FIGS. 4-11) that is located adjacent the delivery position 40e. The gate 44 is vertically spring loaded or otherwise biased downward relative to the upper portion 34 of the frame 22. That is, the gate 44 is spring biased downward into a position at which it will engage, as described below, a stack of flat carton sleeves that rises through the conveying space 40 into the delivery position 40e. Alternatively, the gate 44 could be biased downward in another manner, or could be gravity-controlled.

The gate 44 in the illustrated embodiment is an L-shaped member, made of sheet metal or plastic and including an upper flange 46 and a front flange 48. A pneumatic piston-and-cylinder device or other motive device 50 is connected with the gate 44. The device 50 is selectively operable to raise (and possibly lower) the gate 44.

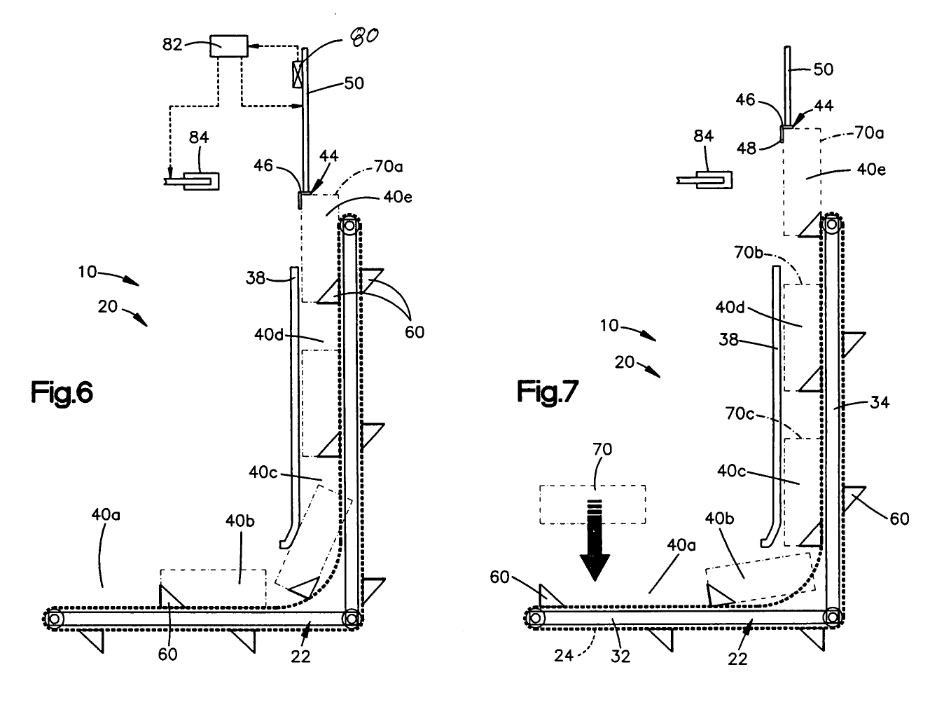

As a result, the gate 44 has at least three positions, in one of which it typically is positioned. In a first or lowest position (FIG. 4), the gate 44 is at the bottom of the delivery position 40e. The gate 44 is in this position when the delivery position 40e is empty. In a second or intermediate position (FIG. 6), the gate 44 is biased down to the top of the delivery position 40e. The gate 44 is in this position when a stack of carton sleeves is in the delivery position 40e. In a third or highest position (FIG. 7), the gate 44 is held upward by the device 50, against the bias, above the top of the delivery position 40e. The gate 44 is in this third position when the gripper 84 is removing a stack from the delivery position 40e.

The frame 22 (FIGS. 1-3) supports the arrangement 24 for movement along the frame in response to an actuatable drive, shown schematically at 52 in FIGS. 1 and 2. The drive 52 may include an electric motor, as one example. The drive 52 may be manually actuated, for manual indexing of the arrangement 24 along the frame 22. The drive 52 may, alternatively or in addition, be automatically actuated, for automatic, or condition-responsive, indexing of the arrangement 24 along the frame 22. The movement of the arrangement 24 along the frame 22 may, alternatively, be continuous movement.

The arrangement 24 is endless and may include, for example, one or more chains that are driven along the frame 22 by the drive 52. The arrangement 24 includes a number of the carriers 60. Each carrier 60 is sized and configured to accept a stack of flat carton sleeves. The number of carriers 60 is equal to the number of positions 40a-40e, plus additional carriers (about double) so that the carriers can, after being unloaded, wrap around the back of the conveyor 20 and return underneath to the loading position 40a. The number of carton sleeves that each compartment of each carrier 60 holds is selected to be equal to a number that can be gripped by the gripper mechanism 84, as described below, and moved into the magazine 14. In the illustrated embodiment, each carrier 60 has two compartments and thus is usable for loading two stacks or groups of carton sleeves.

Each carrier 60 comprises a tray or pusher 62, which is an L-shaped member, possibly of sheet metal, including first and second flanges 64 and 66. The carrier 60 has a back comprised of the first flange 64, that is oriented horizontally when the carrier 60 is in the loading position 40a, so as to support sleeves that are initially loaded into the carrier. The carrier back 64 is oriented vertically when the carrier is in the upper portion 34 of the frame 22, to help prevent the sleeves from falling out of the back of the conveying space 40.

Each carrier 60 has an open front opposite the back, for enabling the placement of carton sleeves in the carrier. This open front also enables the later gripping of the carton sleeves, as a group, by the gripper. The carrier 60 also has ends 68 that laterally define the two compartments and that help to prevent lateral movement of the stacks of carton sleeves when they are in the carrier.

The carrier 60 has a bottom side that is outermost when the carrier is in the loading position 40a. The bottom side comprises the second flange 66, that is oriented vertically when the carrier 60 is in the loading position 40a, so as to block the carton sleeves from falling outward out of the carrier as it is being loaded. The bottom side 66 of the carrier 60 is oriented horizontally when the carrier is in the upper portion of the frame 22, to prevent the carton sleeves from falling downward out of the carrier.

When the magazine 14 is to be loaded initially, the conveyor 20 is indexed so that the first carrier 60a is in the loading section, for example, in the loading position 40a (FIG. 4). The carrier 60 that is placed in the loading position 40a could be any one of the carriers 60; the particular carrier that is designated in FIG. 4 with the reference numeral 60a is referred to herein as “the first carrier” for ease of reference in following it through the described operation of the loader 10.

The operator places a stack 70 of flat carton sleeves into the first carrier 60a. Because the loading position 40a is located at or near the outer edge of the loader 10 and the filling machine 12, the carrier 60a is easily accessible to an operator standing adjacent the machine. Because the loading position 40a is located vertically at a relatively low height off the floor 12, for example at hip height, as compared to the magazines 14, it is easily accessible to an operator standing adjacent the machine, who does not have to reach high up to load carton sleeves, as he would if, for example, he were conventionally loading a belt conveyor directly.

The operator then advances the conveyor 20, for example by indexing. The advancing movement of the conveyor 20 (as shown moving from FIG. 4 to FIG. 5) causes the arrangement 24 to move the filled first carrier 60a inwards, in a direction toward the upper portion 34 of the frame 22. The carrier 60a and its stack 70a move into another position, specifically, the position 40b.

At the same time, an empty second carrier 60 moves into the loading position 40a (FIG. 5). The operator manually loads the second carrier 60.

The operator then advances the conveyor 20 again. The advancing movement of the conveyor 20 moves the filled second carrier 60 inwards into the position 40b, and simultaneously moves the filled first carrier 60a inwards and then upwards into and along the upper portion 34 of the frame 22 to a position 40c. At the same time, an empty third carrier 60 is moved into the loading position 40a. This sequence of manually filling and advancing continues until all the positions 40b-40e, along the lower portion 32 of the frame 22 and along the upper portion 34 of the frame, are filled with stacks, as shown in FIG. 6.

During the filling of the conveyor 20 with stacks 70, when a stack begins to rise from the position 40d into the delivery position 40e, as shown in a comparison of FIGS. 6 and 7, the stack engages the gate 44. As the stack 70 continues its upward movement into the delivery position 40e, the stack pushes the gate 44 upward.

The gate 44 moves upward, from its first position to its second or intermediate position in which it is at the top of the position 40e. When the stack 70 completes its upward movement into the delivery position 40e, the gate 44 remains engaged with the top of the stack. The top flange 46 of the gate 44 provides a downward compressive force on the stack 70, helping to hold the stack in the carrier 60.

The guide 38 does not extend fully over the delivery position 40e. However, the front flange 48 of the gate 44 engages the outer facing side of the stack 70, thus providing an inward force on the stack. As a result, the stack 70 is securely held in the delivery position 40e.

When a filled carrier 60 reaches the delivery position 40e with a stack 70 of carton sleeves, a sensor indicated schematically at 80 (FIG. 6) indicates that fact to a controller 82. The sensor 80 may be responsive to, for example, the position of the gate 44, so that the movement of the gate to its intermediate position sends an appropriate signal. The controller 82 determines, also, the need for flat carton sleeves in the magazine 14.

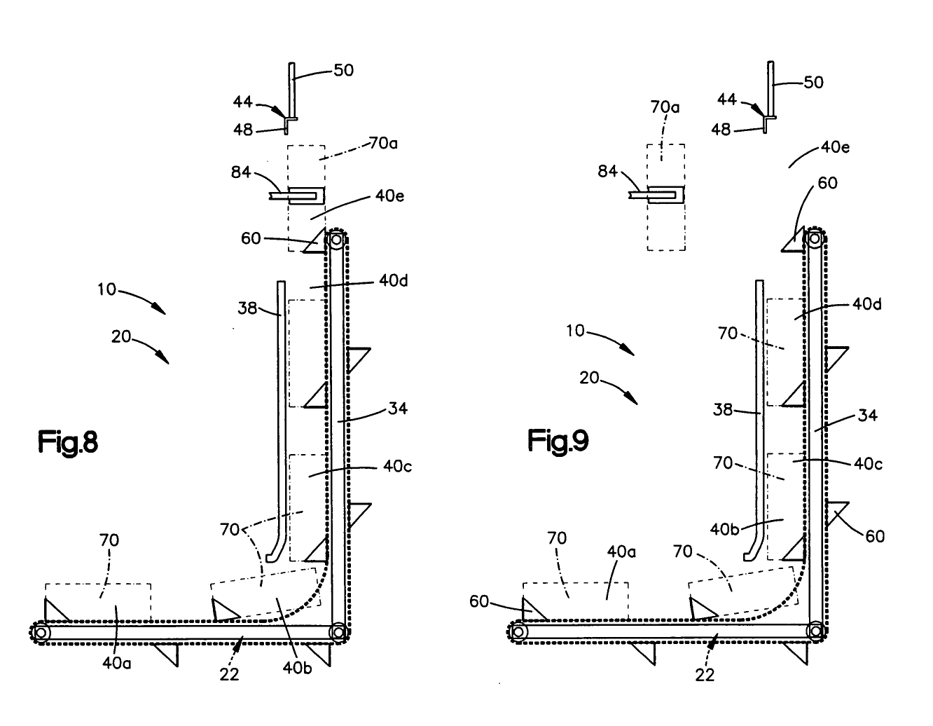

When the controller 82 determines both that a magazine, such as the magazine 14, needs sleeves, and also that one of the compartments in the carrier that is in the delivery position 40e is filled, the controller actuates the gripper 84. The gripper 84 is actuated to move into position to grip the sleeves in the relevant compartment of the uppermost carrier 60 (FIG. 8). After the gripper 84 grips the stack 70 of sleeves in the top carrier, the controller 82 actuates the device 50 to lift the gate 44 a few inches so that the front flange 48 of the gate 44 is clear of the stack 70 (FIG. 8).

At that point, no portion of the frame 22, the arrangement 24, or the guide 38 prevents the stack 70 from coming forward (outward) out of the carrier 60a and thus out of the delivery position 40e. The gripper 84 can then remove the stack 70 from the delivery position 40e by pulling the stack directly outward, away from the upper portion 34 of the frame 22 and the carrier 60a (FIG. 9). The gripper 84 loads the stack 70 into the magazine 14. From the magazine, the individual flat carton sleeves can be delivered, in turn, to the filling machine, for example by a known mechanism such as a suction cup mechanism.

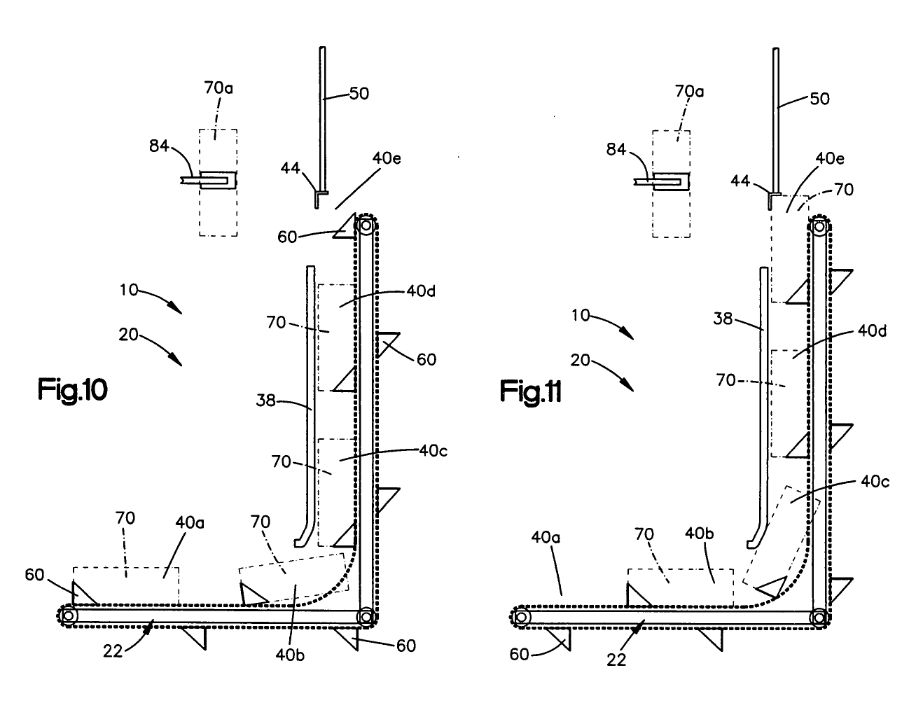

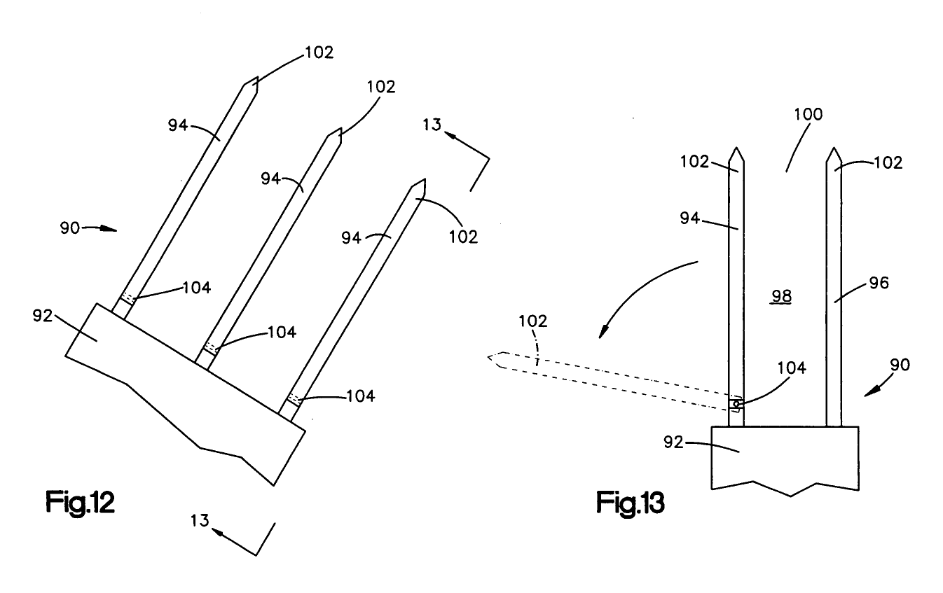

After the stack 70 has been removed from the delivery position 40e by the gripper 84, the air pressure to the device 50 is released, and the gate 44 moves down (FIG. 10). At the same time, the conveyor 22 is indexed or otherwise advanced (FIG. 11) so that the next stack 70, which was in the queuing position 40d, immediately below the delivery position 40e, is moved upward into the delivery position. As this movement occurs, the stack 70 engages the gate 44, which helps to hold the stack in place in the delivery position 40e (FIG. 11).

When this movement of the next stack 70 into the delivery position 40e is completed, the conveyor movement stops. The movement of the conveyor 22 has simultaneously caused an empty carrier 60 to be moved into the loading position 40a as shown in FIG. 4. An operator can then load the empty carrier 60 and start the cycle again. Note that if the carriers include plural compartments, as is illustrated, the conveyor will not cycle until both compartments of the uppermost carrier are emptied by the gripper 84.

The conveyor 20 includes at least one intermediate or queuing position in which stacks 70 queue while being conveyed from the loading position 40a to the delivery position 40e. In this way, a relatively large number of carton sleeves can be provided at one time, that are ready for automatic off-loading into the magazine 14 by the gripper 84. Preferably, but not necessarily, more than one intermediate position is provided. In the illustrated embodiment, three intermediate positions 40b-40d are provided, in the queuing section.

Because the magazines can be filled non-manually from a relatively high level, the magazines can extend relatively highly off the ground, and thus can have a relatively large capacity. The loader and method are suitable to keeping the magazines as full as possible because of the ability to accumulate (queue) one or more groups of carton sleeves in the loader. As a result, the loader can maintain a sufficient number of carton sleeves in the magazine to maintain a high enough pressure urging the carton sleeves towards the outlet mouth of the magazine.

In this regard, it is possible to provide for loading a stack of the sleeves into a magazine so that the leading sleeve of the stack comes to bear face-to-face against a surface portion of the magazine bounding an outlet of the magazine; and pressing against a trailing sleeve of the stack in such manner that the stack comes to bear with a substantially constant pressure against the surface portion as its leading sleeves are withdrawn from the magazine.

As noted above, a filling machine may be of the type with more than one lane, and with more than one magazine per lane. One known filling machine uses two magazines per lane. The loader 10 that is shown and described herein is particularly designed to accommodate (load) two magazines per lane. Specifically, the loader 10 as described above is operable via the gripper 84 to fill either one of the two magazines of a lane, in turn, from either of the two compartments that are in the delivery position. The computer that controls the gripper can select from either compartment of the carrier, to fill either magazine, as needed. The computer can determine which one of the first and second magazines is to be loaded, select a compartment for retrieving therefrom a stack of the carton blanks, and load the selected stack of carton blanks into the selected magazine.

There may be occasion when a magazine of a filling machine needs to be manually loaded. For example, the present loader may be used to help automatically load a magazine, and the loader may temporarily be out of service. In such a case, it is necessary to load the magazine manually. This can be difficult if the top of the magazine is high off the floor, as is feasible when using the present loader. Such a magazine placement is conducive to loading a large number of carton sleeves for the filling machine. The operator may have to stand on a platform and reach very high up to load the magazine manually.

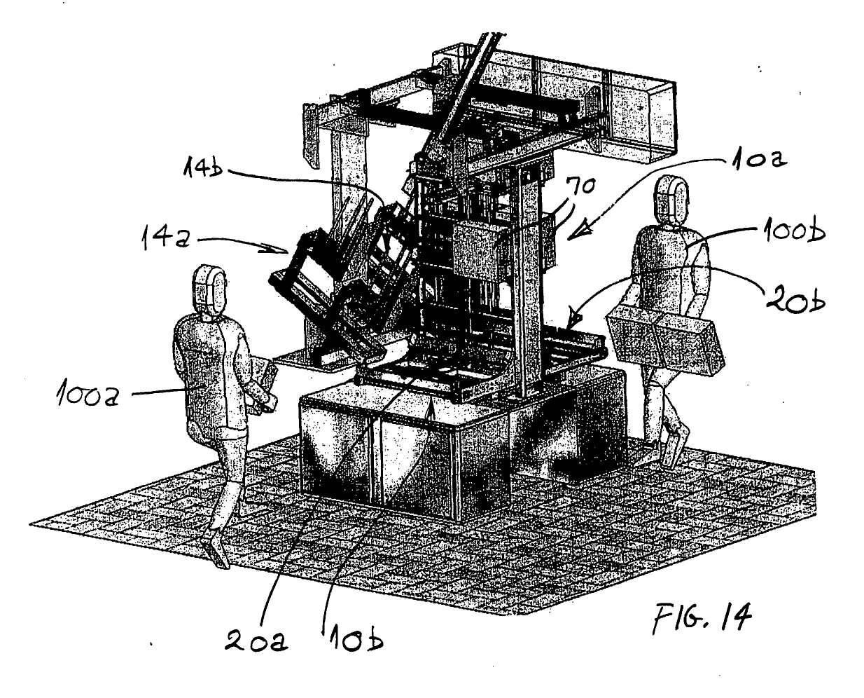

To address this situation, the magazine can be loaded either manually or automatically. One embodiment of such a magazine is shown schematically at 90 in Figs. 12 and 13. The magazine 90 includes a base 92 from which a plurality of rods 94 and 96 extend upward. The rods 94 and 96 form walls that at least partially define a volume 98 in which stacks of carton sleeves can be loaded, for example, by the gripper 84 of the present loader. The volume 98 is loaded from its open upper end 100, at the end portions 102 of the rods 94 and 96, by the gripper 84.

If the magazine 90 cannot be loaded automatically, for some reason, then the operator can move one or more of the rods from their first position shown in FIG. 12 to a second position shown in FIG. 13. In the illustrated embodiment, three of the rods numbered 94 have pivot joints 104 and are pivotable about those joints to move them away from the volume 98, as shown in FIG. 13. This movement of the rods 94 opens up the side of the volume 98 and enables loading of flat carton sleeves into the volume from the side, at a relatively low height compared to the top of the magazine 90.

The rods 94 can also be movable away from the volume 98 to enable unloading of the magazine 90, such as in the event that the mechanism for taking the flat carton sleeves from the mouth of the magazine jams, or the sleeves jam in the mouth.

The pivot joints 104 may include detents for holding the rods 94 in the second position. The pivot joints 104 may also be configured so that the rods 94 are spring-loaded or otherwise biased into the first position. The pivot joints 104 may further include a locking mechanism for releasably locking the rods 94 in the first position, to prevent inadvertent opening of the volume 98. In addition, a different number of rods could be movable; or walls formed of material other than rods, such as solid plates on the non-moving sides, could be provided.

FIG. 14 illustrates an embodiment of the present invention that includes first and second conveyors (not shown) at respective opposite sides of the filling machine. Loaders 10a and 10b are loadable manually with the flat carton sleeves on respective opposite sides of the machine. The machine includes first and second pairs 14a and 14b of magazines at respective opposite sides of the machine, towards which the respective conveyors 20a and 20b forward the stacks 70. With this embodiment, a couple of operators 100a and 100b can load the stacks 70 without continually or occasionally obstructing each other.

From the above description of the invention, those skilled in the art will perceive improvements, changes, and modifications in the invention. Such improvements, changes, and modifications within the skill of the art are intended to be included within the scope of the appended claims.

Having described the invention, I claim:

1. A loader for loading stacks of carton blanks into a magazine of a carton filling machine, comprising:
a conveyor having a plurality of carriers movable through a series of sections including a loading section, a delivery section, and a plurality of queuing sections between the loading section and the delivery section; and
the loading section of the conveyor being located at a lower level than the delivery section of the conveyor.

2. A loader as set forth in claim 1 wherein:
the loading section of the conveyor includes a laterally outer end portion of the conveyor and is at a height in the range of from 30 inches to 40 inches off a floor;
the delivery section is significantly higher than the loading section; and
the conveyor includes a queuing section in which stacks of carton blanks are queued while being conveyed from the loading section to the delivery section.

3. A loader as set forth in claim 2 wherein the loading section of the conveyor is at a height of about 36 inches off the floor.

4. A loader as set forth in claim 1 wherein the conveyor has a generally vertically extending upper portion and has a lower portion extending outward from the bottom of the upper portion, the delivery section including a delivery position located at the top of the upper portion of the conveyor, the loading section including a loading position located at the outer end of the lower portion of the conveyor.

5. A loader as set forth in claim 1 wherein the conveyor has a generally L-shaped configuration including an upper portion that extends generally vertically and a lower portion extending generally outward from the bottom of the upper portion.

6. A loader as set forth in claim 1 including a gate that helps to contain a stack of carton blanks in a carrier when the stack is in a delivery position of the conveyor, the gate being selectively removed from engagement with the stack when the stack is gripped by a gripper to enable movement of the stack by the gripper from the loader into a magazine of the filling machine.

7. A loader as set forth in claim 1 wherein:
each carrier is open topped for enabling vertically downward loading of a stack of carton blanks into the carrier, each carrier also having a pusher having a back for helping to support the stack when the carrier is moving horizontally, a bottom side, and two ends, for helping to contain the stack as it moves along the loader between locations;
the loader also includes a frame that supports a fixed guide that helps to contain a stack of carton blanks in a carrier when the stack moves vertically; and
the loader also includes a gate that helps to contain a stack of carton blanks in a carrier when the stack is in a delivery position of the conveyor, the gate being selectively removed from engagement with the stack when the stack is gripped by a gripper to enable movement of the stack by the gripper from the loader into a magazine of the filling machine.

8. A loader as set forth in claim 1, wherein said conveyor is an indexing conveyor.

9. A method of loading stacks of carton blanks for a magazine of a carton filling machine, the method comprising the steps of:
loading a first stack into a first carrier in a loading section of a conveyor;
advancing the conveyor to move the first stack and the first carrier into a queuing section of the conveyor, while simultaneously moving a second carrier into the loading section;
loading a second stack onto the second carrier in the loading section of the conveyor; and thereafter
advancing the conveyor to move the first stack and the first carrier into a delivery section that is located at a higher level than the loading section, simultaneously with moving the second carrier into the queuing section.

10. A method as set forth in claim 9 including performing the step of accumulating a plurality of stacks of carton blanks in respective queuing sub-sections of said queuing section.

11. A method as set forth in claim 9 wherein the machine rests on a floor and wherein the step of loading carton blanks into a carrier in the loading section of the conveyor is performed manually at a height of no more than about 40 inches off the floor.

12. A method as set forth in claim 11 wherein the step of loading carton blanks into a carrier in the loading section of the conveyor is performed at a height in the range of from about 30 inches to about 36 inches off the floor.

13. A method as set forth in claim 9 further including the steps of gripping a stack of carton blanks that is in the delivery section of the conveyor, removing the stack from the conveyor, and loading the stack into a magazine at a level significantly above the level of the loading section.

14. A method as set forth in claim 9 including the step of accumulating at least two stacks of carton blanks in queuing sub-sections between the loading section and the delivery section.

15. A method as set forth in claim 9 further including the steps of gripping a stack of carton blanks that is in the delivery section of the conveyor, removing the stack from the conveyor, and loading the stack into the magazine at a level substantially above the level of the loading section.

16. A magazine for a carton filling machine, comprising:
a base; and
a plurality of rods that extend generally upward from the base and that at least partially define a volume for receiving carton blanks at the top of the chamber for the filling machine;
at least one of the rods being movable temporarily away from the volume to enable loading or unloading of the volume from the side.

17. A magazine as set forth in claim 16 wherein the one rod is spring loaded.

18. A magazine as set forth in claim 16 wherein the one rod has a detent position located away from the volume to enable loading of the volume from the side without manually holding the rod in place.

19. A magazine as set forth in claim 16 including a locking mechanism for releasably locking the one rod to prevent inadvertent opening of the volume.

20. An apparatus for loading a magazine with packaging articles, comprising a conveyor having an input and arranged to lift the articles from the level of the input to a higher level from which the articles can be loaded into the magazine, the input being at substantially hip height for an operator standing on the floor adjacent to the apparatus.

21. A method of loading a magazine with packaging articles, comprising:
receiving the articles onto a conveyor, from an operator standing on the floor adjacent to the conveyor, at a level at substantially hip height for said operator, causing the conveyor to lift the articles to a higher level; and
non-manually loading the articles into the magazine from the higher level.

22. A method of sequentially delivering carton articles in flat condition, comprising:
loading a stack of the articles into a magazine so that the leading article of the stack comes to bear face-to-face against a surface portion of the magazine bounding an outlet of the magazine; and
causing the stack to bear with a substantial pressure against the surface portion as its leading articles are withdrawn from the magazine.

23. A method according to claim 22, wherein the causing of the stack to bear with a substantial pressure against the surface portion is achieved by pressing against a trailing article.

24. A method according to claim 22, wherein the causing of the stack to bear with a substantial pressure against the surface portion is achieved by loading said magazine in such a manner that the leading articles are borne down upon by sufficient others of said articles.

25. An apparatus for delivering packaging articles, comprising an accumulating conveyor for accumulating a plurality of groups of the articles, and a magazine which receives the groups in turn and which delivers the articles of each received group in turn.

26. A method of delivering packaging articles, comprising:
accumulating a plurality of groups of the articles;
supplying the groups in turn to a magazine; and
delivering the articles of the group in the magazine in turn.

27. An apparatus for delivering packaging articles, comprising first and second conveyors at respective opposite sides of the apparatus and loadable manually with the articles, and first and second magazines at the respective opposite sides and towards which the respective conveyors forward the articles.

28. A method of delivering packaging articles, comprising:
receiving manually loaded first and second groups of articles on respective first and second conveyors;
conveying the first and second groups by means of the respective conveyors towards respective first and second magazines; and
non-manually loading the first and second groups into the respective first and second magazines.

29. An apparatus for delivering packaging articles, comprising first and second magazines for delivering packaging articles, and a forwarding device arranged to load the articles into each one of the magazines in turn.

30. A method of delivering packaging articles, comprising loading packaging articles into first and second magazines in turn with a common article-forwarding device.

31. A method as set forth in claim 30 wherein the common article-forwarding device is a gripper.

32. A method as set forth in claim 31, wherein said gripper seizes said articles from a conveyor having a series of carriers, each carrier having two compartments, each compartment being for manually loading a stack of the packaging articles.

33. A method as set forth in claim 32 including the steps of sensing which one of the first and second magazines is to be loaded, selecting a compartment for retrieving therefrom a stack of the packaging articles by said gripper, and loading the selected stack of packaging articles into the selected magazine.
